(19) United States
(12) Patent Application Publication
(10) Pub. No.: US 2015/0154144 A1
(43) Pub. Date: Jun. 4, 2015

(54) METHOD AND APPARATUS FOR PERFORMING SINGLE INSTRUCTION MULTIPLE DATA (SIMD) OPERATION USING PAIRING OF REGISTERS

(71) Applicant: Samsung Electronics Co., Ltd., Suwon-si (KR)

(72) Inventors: Kyeong Yeon KIM, Hwaseong-si (KR); Navneet BASUTKAR, Yongin-si (KR); Young Hwan PARK, Yongin-si (KR); Ki Taek BAE, Hwaseong-si (KR); Ho YANG, Hwaseong-si (KR)

(73) Assignee: SAMSUNG ELECTRONICS CO., LTD., Suwon-si (KR)

(21) Appl. No.: 14/556,576

(22) Filed: Dec. 1, 2014

(30) Foreign Application Priority Data
Dec. 2, 2013 (KR) 10-2013-0148482

(51) Int. Cl. G06F 15/82; G06F 9/30

(52) U.S. Cl. CPC G06F 15/82; G06F 9/30098; G06F 9/3001

(57) ABSTRACT

An apparatus and a method for performing a single instruction multiple data (SIMD) operation using pairing of registers are provided. An example SIMD apparatus includes a first register configured to store first result data generated by dyadic operators, and a second register configured to store second result data generated by the dyadic operators. The first register and the second register may be paired with each other. Examples also include the use of more than two dyadic operators and/or registers, as well as intermediate registers.

### CROSS-REFERENCE TO RELATED APPLICATIONS

This application claims the benefit under 35 USC 119(a) of Korean Patent Application No. 10-2013-0148482 filed on Dec. 2, 2013, in the Korean Intellectual Property Office, the entire disclosure of which is incorporated herein by reference for all purposes.

### BACKGROUND

1. Field

The following description relates to a method and an apparatus for performing a single instruction multiple data (SIMD) operation using pairing of registers.

2. Description of Related Art

Single instruction multiple data (SIMD) is a type of parallel computing in which multiple pieces of data are processed using a single instruction. The SIMD enables a plurality of processing apparatuses to simultaneously process multiple pieces of data by applying the same operation or similar operations to each piece of the multiple pieces of data. For example, the SIMD techniques may be used in a vector processor. The above-described computing structure may be based on data level parallelism (DLP). For example, the SIMD may be applied to a multimedia field, or a communication field.

A SIMD operation apparatus may require multiple pieces of data that are to be processed by an instruction. The SIMD operation apparatus may enhance performance of a computer system by processing the multiple pieces of data using a single instruction.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a single instruction multiple data (SIMD) operation apparatus includes dyadic operators configured to perform dyadic operations on pieces of input data, a first register configured to store first result data generated by the dyadic operators, and a second register configured to store second result data generated by the dyadic operators, wherein the first register and the second register are paired with each other.

A dyadic operation performed by each of the dyadic operators may be included in a single instruction.

The SIMD operation apparatus may further include an intermediate register, wherein the dyadic operators store intermediate result data in the intermediate register.

The first register may output the first result data independently of the second register, and the second register may output the second result data independently of the first register.

The dyadic operators may perform dyadic operations, in parallel, on the pieces of input data.

The pieces of input data, the first result data, and the second result data may be vector data, or dual vector data, and the first register, and the second register may be vector registers.

When the single instruction corresponds to an addition-subtraction instruction, the pieces of input data may include first input data and second input data, and the dyadic operators may include a first dyadic operator configured to perform addition of the first input data and the second input data, and to generate the first result data, and a second dyadic operator configured to perform subtraction of the second input data from the first input data, and to generate the second result data.

When the single instruction corresponds to a min-max instruction, the pieces of input data may include first input data and second input data, and the dyadic operators may include a first dyadic operator configured to extract data with a lesser value between the first input data and the second input data, and to generate the first result data, and a second dyadic operator configured to extract data with a greater value between the first input data and the second input data, and to generate the second result data.

When the single instruction corresponds to a butterfly instruction, the pieces of input data may include first input data, second input data, and third input data, and the dyadic operators may include a first dyadic operator configured to perform addition of the first input data and the second input data, and to generate the first result data, a second dyadic operator configured to perform subtraction of the second input data from the first input data, and to generate intermediate result data, and a third dyadic operator configured to perform complex multiplication of the intermediate result data and the third input data, and to generate the second result data.

The SIMD operation apparatus may further include an intermediate register configured to store the intermediate result data, wherein the third dyadic operator loads the intermediate result data from the intermediate register, and generates the second result data.

In another general aspect, a single instruction multiple data (SIMD) operation apparatus includes dyadic operators configured to perform dyadic operations on pieces of input data, and registers configured to store pieces of result data generated by the dyadic operators, respectively, wherein the registers are grouped.

The dyadic operators may perform dyadic operations included in a single instruction.

The SIMD operation apparatus may further include an intermediate register, wherein the dyadic operators store intermediate result data in the intermediate register.

The registers may independently output the pieces of result data respectively stored in the registers.

The dyadic operators may perform dyadic operations, in parallel, on the pieces of input data.

The pieces of input data, and the pieces of result data may be vector data, or dual vector data, and the registers may be vector registers.

In another general aspect, a single instruction multiple data (SIMD) operation method includes generating first result data and second result data by performing a dyadic operation on pieces of input data, storing the first result data in a first register, and storing the second result data in a second register, wherein the first register and the second register are paired with each other.

In another general aspect, a single instruction multiple data (SIMD) operation method includes generating pieces of result data by performing a dyadic operation on pieces of input data, and storing the pieces of result data in registers, respectively, wherein the registers are grouped.

In another general aspect, a single instruction multiple data (SIMD) operation apparatus includes dyadic operators configured to generate pieces of result data by performing dyadic operations on pieces of input data, and grouped registers configured to store the pieces of result data.

A dyadic operation performed by each of the dyadic operators is included in a single instruction.

Other features and aspects will be apparent from the following detailed description, the drawings, and the claims.

### BRIEF DESCRIPTION OF THE DRAWINGS

FIG. 1 is a block diagram illustrating an example of a single instruction multiple data (SIMD) operation apparatus.

FIG. 2 is a diagram illustrating another example of a SIMD operation apparatus.

FIGS. 3A and 3B are diagrams illustrating examples of pairing of two registers.

FIG. 4 is a diagram illustrating an example of a SIMD operation apparatus configured to execute an addition-subtraction instruction.

FIG. 5 is a diagram illustrating an example of a SIMD operation apparatus configured to execute a min-max instruction.

FIG. 6 is a diagram illustrating an example of a SIMD operation apparatus configured to execute a butterfly instruction.

FIG. 7 is a flowchart illustrating an example of a SIMD operation method.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

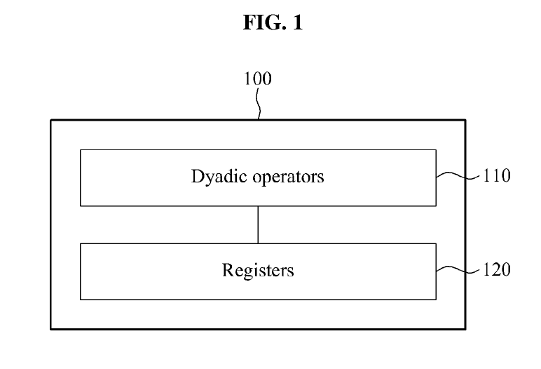

FIG. 1 illustrates an example of a single instruction multiple data (SIMD) operation apparatus.

Referring to FIG. 1, a SIMD operation apparatus 100 for performing a dyadic operation includes dyadic operators 110, and registers 120. In an example, the registers 120 are grouped. A dyadic operator denotes an operator that takes two operands. The SIMD operation apparatus 100 potentially has an n-way SIMD architecture in which the n pieces of data are processed in parallel. Thus, the SIMD operation apparatus 100 executes a single instruction, using an n-way data path.

Each of the dyadic operators 110 performs a dyadic operation on pieces of input data. In examples, the pieces of input data are vector data, or dual vector data. For example, each of the pieces of input data may include a plurality of vectors, or a plurality of dual vectors. In such an example, the plurality of vectors and the plurality of dual vectors may represent complex numbers. The pieces of input data are potentially stored in registers that are set in advance. In an example, registers to which the pieces of input data are input are different from the registers 120 that will be described below. In this example, the pieces of input data are represented as operands.

The dyadic operators 110 perform dyadic operations, in parallel, on the pieces of input data. Accordingly, a cycle delay of the SIMD operation apparatus 100 is reduced, and a performance may be enhanced by such parallelism.

The dyadic operators 110 perform dyadic operations on the pieces of input data, independently and in parallel. In an example, two dyadic operators, for example, a first dyadic operator and a second dyadic operator, are included in the SIMD operation apparatus 100. In such an example the first dyadic operator generates first result data by performing a first dyadic operation on first input data and second input data, and the second dyadic operator generates second result data by performing a second dyadic operation on the first input data and the second input data.

Dyadic operations performed by the dyadic operators 110, in an example, are included in a single instruction. Examples of the single instruction include an addition-subtraction instruction, a min-max instruction, a butterfly instruction, and an interleave instruction. However, these are merely examples of the single instruction, and other types of instruction are used as the single instruction in other examples. For example, the single instruction includes at least one dyadic operation. With respect to these examples, the addition-subtraction instruction includes addition and subtraction operations, each of which requires two operands. The min-max instruction includes a dyadic operation to extract a minimum value, and a dyadic operation to extract a maximum value. In the above example, when the addition-subtraction instruction is executed, the first dyadic operator generates first result data by performing addition of the first input data and the second input data, and the second dyadic operator generates second result data by performing subtraction of the first input data and the second input data. Hence, an addition-subtraction instruction finds the sum and the difference of its two operands. Similarly, a min-max instruction identifies the lesser and the greater of its two operands.

Additionally, the registers 120 store pieces of result data generated by the dyadic operators 110, respectively. The registers 120 are, for example, vector registers. In an example in which three registers, for example, a first register, a second register, and a third register are included in the SIMD operation apparatus 100, the dyadic operators 110 generate first result data, second result data, and third result data. In this example, the first register, the second register, and the third register store a first result value, a second result value, and a third result value, respectively.

For example, the two registers 120 potentially independently output the pieces of result data that are respectively stored in the registers 120. Additionally, the registers 120 are potentially grouped. In such an example, grouping of the registers 120 indicates that the first result data through the third result data are generated by executing the same single instruction. When each piece of result data is stored in the grouped registers 120, a cycle performance of the SIMD operation apparatus 100 is possibly doubled, and in such a situation, an additional operation to determine predetermined result data is not required. For example, when pieces of result data are stored in a single register, and when a first result data among the pieces of result data is output, the SIMD operation apparatus 100 loads all of the pieces of result data from the single register, and extracts the first result data from the pieces of result data using a separate operation. The SIMD operation apparatus 100 stores the pieces of result data in the registers 120, respectively, independently accesses a register in which the first result data is stored, and outputs the first result data. Accordingly, the cycle performance of the SIMD operation apparatus 100 is doubled, because each operation potentially generates additional results without a need to perform an additional operation.

In an example, a bit width of input data may be identical to a bit width of output data. For example, a bit width of each of the registers 120 may be identical to a bit width of input data, such as 256 bits.

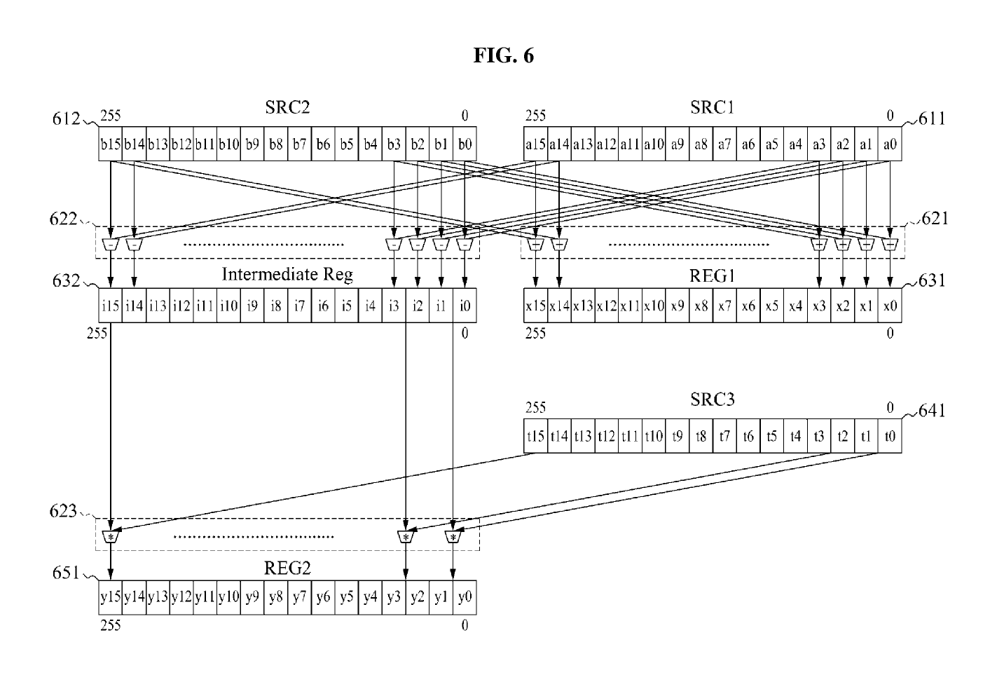

The SIMD operation apparatus 100 optionally includes at least one intermediate register. For example, when a dyadic operation is performed on pieces of input data, the dyadic operators 110 potentially generate intermediate result data. The at least one intermediate register then stores the intermediate result data, and the two dyadic operators 110 load the intermediate result data from the at least one intermediate register, and perform a dyadic operation. For example, when a butterfly instruction is executed by the dyadic operators 110, the dyadic operators 110 store intermediate result data in the at least one intermediate register, and perform complex multiplication included in the butterfly instruction, based on the intermediate result data. An example of executing the butterfly instruction is further described with reference to FIG. 6.

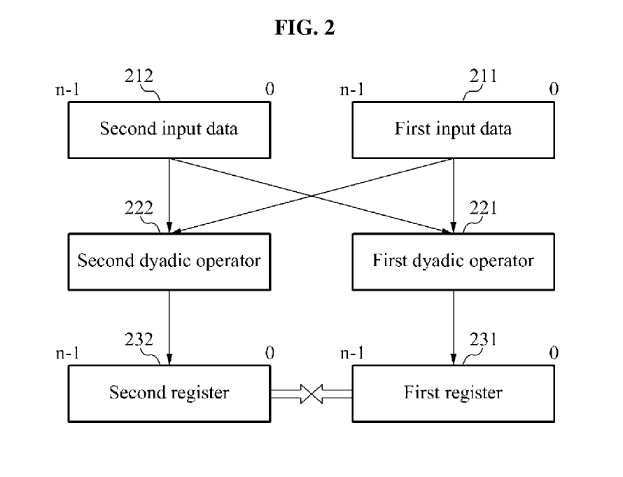

FIG. 2 illustrates another example of a SIMD operation apparatus.

Referring to FIG. 2, a SIMD operation apparatus includes first input data 211, second input data 212, a first dyadic operator 221, a second dyadic operator 222, a first register 231, and a second register 232. For example, the first input data 211 and the second input data 212 are stored in a register that is set in advance. The first input data 211 and the second input data 212 are, for example, vector data, or dual vector data.

As discussed, the first input data 211, the second input data 212, the first register 231, and the second register 232 have the same bit width. In the example of FIG. 2, each of the first input data 211, the second input data 212, the first register 231, and the second register 232 may include n−1 bits.

In the example of FIG. 2, the first dyadic operator 221, and the second dyadic operator 222 perform dyadic operations, in parallel, on pieces of input data. Accordingly, a cycle delay of the SIMD operation apparatus is reduced, and a performance is enhanced.

A dyadic operation performed by the first dyadic operator 221 is identical to or different from a dyadic operation performed by the second dyadic operator 222, in various examples. The dyadic operation performed by the first dyadic operator 221 and the dyadic operation performed by the second dyadic operator 222 are potentially included in a single instruction. For example, when the SIMD operation apparatus executes a min-max instruction, the first dyadic operator 221 performs a dyadic operation to extract data with a lesser value between first input data and second input data, and the second dyadic operator 222 may perform a dyadic operation to extract data with a greater value between the first input data and the second input data. Hence, such a min-max instruction generates the results of two related dyadic operators at the same time.

In the example of FIG. 2, the first register 231 stores first result data generated by the first dyadic operator 221, and the second register 232 stores second result data generated by the second dyadic operator 222. Input data are, for example, vector data, or dual vector data, and the first register 231 and the second register 232 are, for example, vector registers. The first register 231 outputs the stored first result data, independently of the second register 232, and the second register 232 outputs the stored second result data, independently of the first register 231. The first register 231 and the second register 232 are paired with each other and accordingly, pairing of the first register 231 and the second register 232 indicates that the first result data stored in the first register 231 and the second result data stored in the second register 232 are generated by executing the same single instruction. In the example of FIG. 2, each result data is stored in the first register 231 and the second register 232 that are paired with each other, and accordingly a cycle performance of the SIMD operation apparatus is potentially halved. For example, to output the second result data, the SIMD operation apparatus is able to independently access the second register 232, instead of performing an additional operation, unlike an example in which the first result data and the second result data are stored in a single register and hence they cannot be independently accessed.

The SIMD operation apparatus optionally includes at least one intermediate register. When each of the first dyadic operator 221 and the second dyadic operator 222 performs a dyadic operation on the first input data 211, and the second input data 212, the at least one intermediate register generates intermediate result data. The at least one intermediate register stores the intermediate result data, and the first dyadic operator 221 or the second dyadic operator 222 loads the intermediate result data from the at least one intermediate register, and performs a dyadic operation.

In an example, the SIMD operation apparatus executes an interleave instruction. The interleave instruction includes, for example, an interleave_low dyadic operation, and an interleave_high dyadic operation. In a specific example, the first input data 211 is [a, b, c, d], and the second input data 212 is [p, q, r, s]. In this example, [a, b, c, d], and [p, q, r, s] are vector data or dual vector data. In the first input data 211, [a, b] are set as low data, and [c, d] are set as high data. In the second input data 212, [p, q] are set as low data, and [r, s] are set as high data. The first dyadic operator 221 performs an interleave_low dyadic operation on the first input data 211 and the second input data 212, and the second dyadic operator 222 performs an interleave_high dyadic operation on the first input data 211 and the second input data 212. When the interleave_low dyadic operation is performed, the first dyadic operator 221 extracts low data between the first input data 211 and the second input data 222, and generates first result data [a, p, b, q]. When the interleave_high dyadic operation is performed, the second dyadic operator 222 extracts high data between the first input data 211 and the second input data 222, and generates second result data [c, r, d, s]. The first register 231 stores the first result data [a, p, b, q], and the second register 232 stores the second result data [c, r, d, s]. In an example, an interleave instruction is implemented based on a pseudo-code presented in Table 1.

TABLE 1
r0 = I_S32_INTERLEAVE_LOW(in0, in16); //First dyadic operation
r16 = I_S32_INTERLEAVE_HIGH(in0, in16); //Second dyadic
operation
>> above two operations are combined to form a single dyadic
instruction as follows
r16_r0 = I_S32_INTERLEAVE_LOW_HIGH(in0, in16);

In Table 1, in0 represents the first input data 211, and in16 represents the second input data 212. Additionally, r0 represents first output data, and r16 represents second output data. The first dyadic operation and the second dyadic operation are coalesced to form on dyadic SIMD instruction. The r16_r0 represent a paired vector output stored in a paired vector registers.

In an example, the SIMD operation apparatus including the first input data 211, the second input data 212, the first register 231, and the second register 232 are implemented based on pseudo-code presented in Table 2.

TABLE 2
Consider the following pseudo code,
Pseudo code:

Struct SIMD_Vector
{
int array[n];
}
Struct SIMD_DualVector
{
SIMD_Vector a;
SIMD_Vector b;
};
SIMD_Vector SRC1, SRC2; (or SIMD_DualVector SRC1, SRC2)
SIMD_DualVector OUT;

In Table 2, a data type of SIMD_Vector represents a vector array with a length of “n”, and SIMD_DualVector includes two related SIMD_Vectors.

To perform two dyadic operations in the SIMD operation apparatus, the first dyadic operator 221 sets SRC1 as first input data and sets SRC2 as second input data. In an example, when SRC1 and SRC2 are defined in a SIMD_DualVector, the first dyadic operator 221 sets either SRC1.a or SRC1.b as first input data, sets either SRC2.a or SRC2.b as second input data, and performs two dyadic operations.

In the example of Table 2, SIMD_DualVector OUT includes vectors OUT.a and OUT.b. The vector OUT.a represents first result data, and the vector OUT.b represents second result data. The vector OUT.a is mapped with the first register 231, and the vector OUT.b is mapped with the second register 232.

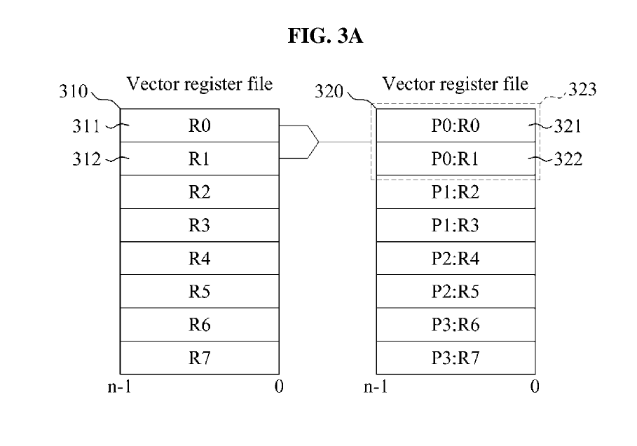

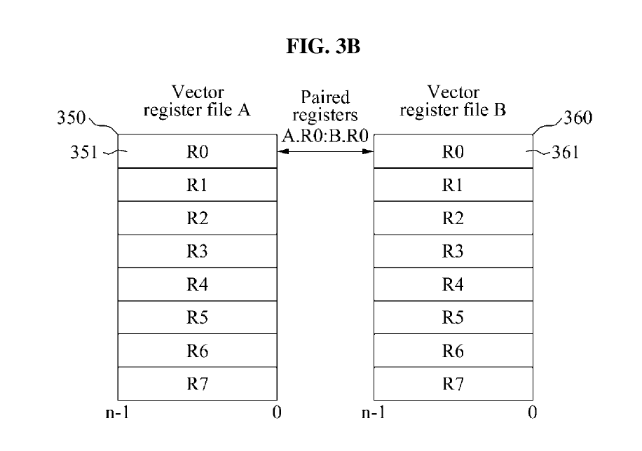

FIGS. 3A and 3B illustrate examples of pairing of two registers.

FIG. 3A illustrates an example in which vector registers are paired with each other in a single vector register file.

Referring to the example of FIG. 3A, a plurality of registers are included in a single vector register file, for example, a vector register file 310. In such an example, the plurality of registers included in the vector register file 310 are paired with each other, and the paired registers can been visualized as shown in vector register file 320. For example, a first register R0 311 and a second register R1 312 are coupled to each other, and are represented as registers P0:R0 321 and P0:R1 322 in the vector register file 320. A couple register 323 including the registers P0:R0 321 and P0:R1 322 is assigned to a single instruction to output two pieces of result data, within the vector register file 320. The registers P0:R0 321 and P0:R1 322 potentially respectively correspond to two different parallel dyadic operations.

In an example, a compiler processes the registers P0:R0 321 and P0:R1 322 during scheduling of a dyadic operation. Additionally, in such an example, the registers P0:R0 321 and P0:R1 322 potentially operate independently of each other, and in such a situation the compiler independently accesses the registers P0:R0 321 and P0:R1 322.

FIG. 3B illustrates an example in which vector registers are paired with each other from different vector register files.

Referring to the example of FIG. 3B, a plurality of registers are included in each of different register files, for example, a vector register file A 350 and a vector register file B 360. A plurality of registers in the vector register file A 350 are paired with a plurality of registers in the vector register file B 360. For example, a first register R0 351 in the vector register file A 350 is coupled to a second register R0 361 in the vector register file B 360. The first register R0 351 and the second register R0 361 that are coupled are assigned to a single instruction to output two pieces of result data. In such an example, the first register R0 351 and the second register R0 361 respectively correspond to two different parallel dyadic operations. In an example, a compiler processes the first register R0 351 and the second register R0 361 during scheduling of a dyadic operation. Additionally, the first register R0 351 and the second register R0 361 potentially operate independently of each other, and the compiler potentially has independent access to the first register R0 351 and the second register R0 361.

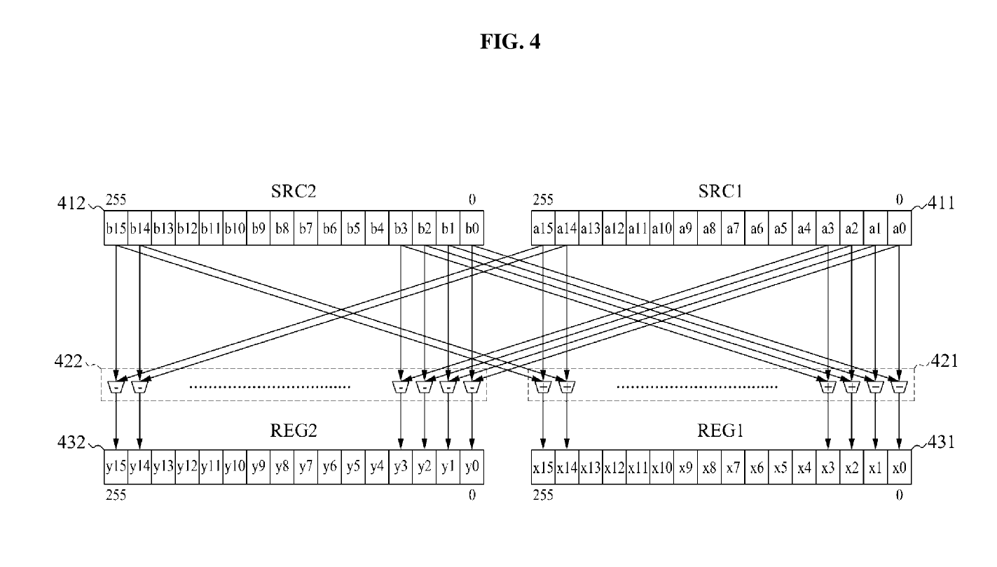

FIG. 4 illustrates an example of a SIMD operation apparatus configured to execute an addition-subtraction instruction.

Referring to the example of FIG. 4, a SIMD operation apparatus includes first input data 411, second input data 412, a first dyadic operator 421, a second dyadic operator 422, a first register 431, and a second register 432. In this example, each of the first input data 411, the second input data 412, the first register 431, and the second register 432 includes 256 bits. The first dyadic operator 421 generates first result data by performing addition of the first input data 411 and the second input data 412. The second dyadic operator 422 generates second result data by performing subtraction of the second input data 412 from the first input data 411. The first register 431 stores the first result data and the second register 432 stores the second result data. In the example of FIG. 4, the first register 431 and the second register 432 respectively output the first result data and the second result data, independently of each other.

In an example, an addition-subtraction instruction is implemented based on a code described in Table 3.

TABLE 3

A0 = I_S32_SAT_ADD(in0, in64); // First dyadic operator 421
A0m = I_S32_SAT_SUB(in0, in64); // Second dyadic operator 422
A0m_A0 = I_S32_SAT_ADD_SUB(in0, in64); // Combined
addition-subtraction operation in a single SIMD dyadic instruction.

In the example of Table 3, in0 represents the first input data 411, and in64 represents the second input data 412. Additionally, A0 represents first output data, and A0m represents second output data. A0m_A0 represents dual vector output data A0 and A0m paired together, yet accessible individually by the compiler.

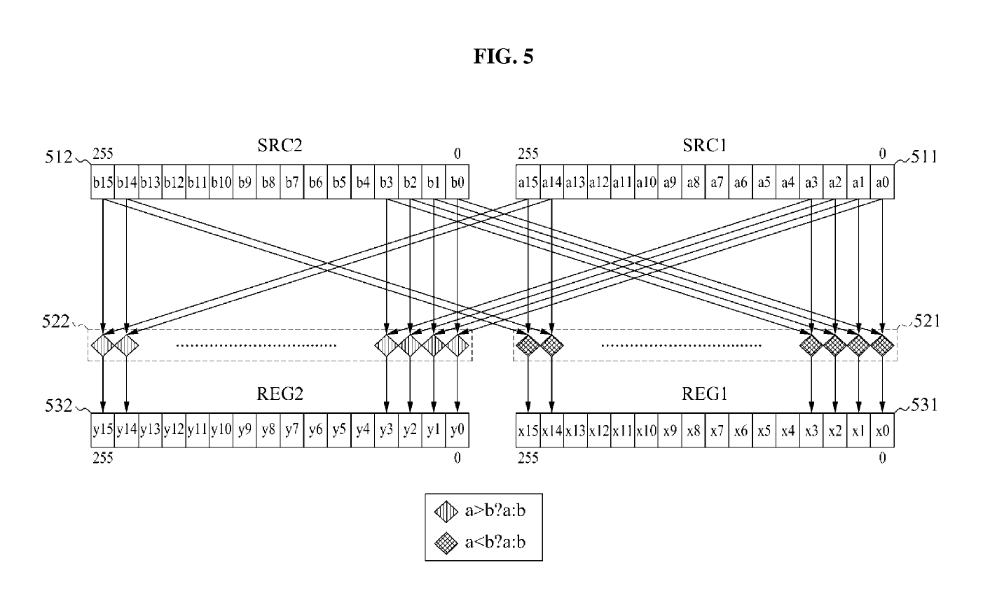

FIG. 5 illustrates an example of a SIMD operation apparatus configured to execute a min-max instruction.

Referring to the example of FIG. 5, a SIMD operation apparatus include first input data 511, second input data 512, a first dyadic operator 521, a second dyadic operator 522, a first register 531, and a second register 532. As discussed above, in an example, each of the first input data 511, the second input data 512, the first register 531, and the second register 532 includes 256 bits.

The first dyadic operator 521 extracts data with a lesser value between the first input data 511 and the second input data 512, and generates first result data. The second dyadic operator 522 extracts data with a greater value between the first input data 511 and the second input data 512, and generates second result data. For example, the first dyadic operator 521 extracts a vector a0 included in the first input data 511 and generates first result data, and the second dyadic operator 522 extracts a vector b0 included in the second input data 512 and generates second result data. In this example, the vector a0 is assumed to have a lesser value than the vector b0.

In the example of FIG. 5, the first register 531, and the second register 532 store the first result data, and the second result data, respectively. In such an example, the first register 531, and the second register 532 output the first result data and the second result data, independently of each other.

FIG. 6 illustrates an example of a SIMD operation apparatus configured to execute a butterfly instruction.

Referring to the example of FIG. 6, a SIMD operation apparatus includes first input data 611, second input data 612, third input data 641, a first dyadic operator 621, a second dyadic operator 622, a third dyadic operator 623, a first register 631, an intermediate register 632, and a second register 651. In this example, each of the first input data 611, the second input data 612, the third input data 641, the first register 631, the intermediate register 632, and the second register 651 includes 256 bits.

The first dyadic operator 621 performs addition of the first input data 611 and the second input data 612, and generates first result data. The second dyadic operator 622 performs subtraction of the second input data 612 from the first input data 611, and generates intermediate result data. The intermediate register 632 stores the intermediate result data.

In this example, the third dyadic operator 623 loads the intermediate result data from the intermediate register 632. The third dyadic operator 623 performs complex multiplication of the intermediate result data and the third input data 641, and generates second result data.

The first register 631 and the second register 651 store the first result data and the second result data, respectively. In this example, the first register 631 and the second register 651 output the first result data and the second result data independently of each other.

In an example, a butterfly instruction is implemented based on code presented in Table 4.

TABLE 4
B0 = I_S32_SAT_ADD_ASR(A0, A32); // First dyadic operator 621
B0m = I_S32_SAT_SUB(A0, A32); // Second dyadic operator 622
B32 = I_S32_SAT_CMUL(B0m, alfa, DecShift); // Third dyadic
operator 623
//One single butterfly instruction includes above three operations
B32_B0 = I_S32_BUTTERFLY(A0, A32, alfa)

In the example of Table 4, A0, A32, and alfa represent the first input data 611, the second input data 612, and the third input data 641, respectively. Additionally, B0m, B0, and B32 represent the intermediate result data, first output data, and second output data, respectively. B32_B0 represents dual vector output data A0 and A0m paired together, yet accessible individually by the compiler.

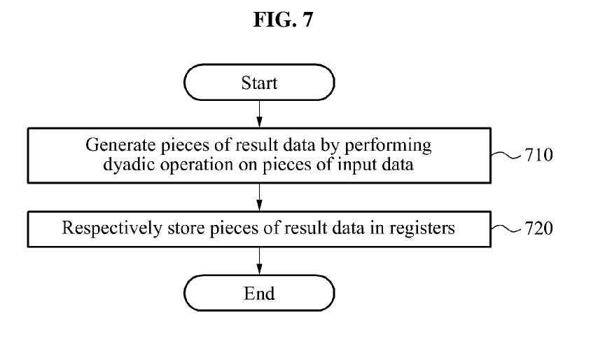

FIG. 7 illustrates an example of a SIMD operation method.

Referring to FIG. 7, in 710, the method generates pieces of result data by performing a dyadic operation on pieces of input data. For example, a SIMD operation apparatus generates pieces of result data by performing a dyadic operation on pieces of input data.

In 720, the method respectively stores the pieces of result data in registers. For example, SIMD operation apparatus respectively stores the pieces of result data in registers. In an example, the registers are grouped.

Information described with reference to FIGS. 1 through 5 may equally be applied to the SIMD operation method of FIG. 7 and accordingly, further description of the SIMD operation method are omitted herein for brevity.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a hardware component may include multiple processors or a processor and a controller. In addition, different processing configurations are possible, such as parallel processors.

The methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The media may also include, alone or in combination with the software program instructions, data files, data structures, and the like. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

As a non-exhaustive illustration only, a terminal/device/unit described herein may refer to mobile devices such as, for example, a cellular phone, a smart phone, a wearable smart device (such as, for example, a ring, a watch, a pair of glasses, a bracelet, an ankle bracket, a belt, a necklace, an earring, a headband, a helmet, a device embedded in the cloths or the like), a personal computer (PC), a tablet personal computer (tablet), a phablet, a personal digital assistant (PDA), a digital camera, a portable game console, an MP3 player, a portable/personal multimedia player (PMP), a handheld e-book, an ultra mobile personal computer (UMPC), a portable lab-top PC, a global positioning system (GPS) navigation, and devices such as a high definition television (HDTV), an optical disc player, a DVD player, a Blu-ray player, a setup box, or any other device capable of wireless communication or network communication consistent with that disclosed herein. In a non-exhaustive example, the wearable device may be self-mountable on the body of the user, such as, for example, the glasses or the bracelet. In another non-exhaustive example, the wearable device may be mounted on the body of the user through an attaching device, such as, for example, attaching a smart phone or a tablet to the arm of a user using an armband, or hanging the wearable device around the neck of a user using a lanyard.

A computing system or a computer may include a microprocessor that is electrically connected to a bus, a user interface, and a memory controller, and may further include a flash memory device. The flash memory device may store N-bit data via the memory controller. The N-bit data may be data that has been processed and/or is to be processed by the microprocessor, and N may be an integer equal to or greater than 1. If the computing system or computer is a mobile device, a battery may be provided to supply power to operate the computing system or computer. It will be apparent to one of ordinary skill in the art that the computing system or computer may further include an application chipset, a camera image processor, a mobile Dynamic Random Access Memory (DRAM), and any other device known to one of ordinary skill in the art to be included in a computing system or computer. The memory controller and the flash memory device may constitute a solid-state drive or disk (SSD) that uses a non-volatile memory to store data.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A single instruction multiple data (SIMD) operation apparatus, comprising:
dyadic operators configured to perform dyadic operations on pieces of input data;
a first register configured to store first result data generated by the dyadic operators; and
a second register configured to store second result data generated by the dyadic operators,
wherein the first register and the second register are paired with each other.

2. The SIMD operation apparatus of claim 1, wherein a dyadic operation performed by each of the dyadic operators is comprised in a single instruction.

3. The SIMD operation apparatus of claim 1, further comprising:
an intermediate register,
wherein the dyadic operators store intermediate result data in the intermediate register.

4. The SIMD operation apparatus of claim 1, wherein the first register outputs the first result data independently of the second register, and
wherein the second register outputs the second result data independently of the first register.

5. The SIMD operation apparatus of claim 1, wherein the dyadic operators perform dyadic operations, in parallel, on the pieces of input data.

6. The SIMD operation apparatus of claim 1, wherein the pieces of input data, the first result data, and the second result data are vector data, or dual vector data, and
wherein the first register, and the second register are vector registers.

7. The SIMD operation apparatus of claim 2, wherein, when the single instruction corresponds to an addition-subtraction instruction, the pieces of input data comprise first input data and second input data, and
wherein the dyadic operators comprise:
a first dyadic operator configured to perform addition of the first input data and the second input data, and to generate the first result data, and
a second dyadic operator configured to perform subtraction of the second input data from the first input data, and to generate the second result data.

8. The SIMD operation apparatus of claim 2, wherein, when the single instruction corresponds to a min-max instruction, the pieces of input data comprise first input data and second input data, and
wherein the dyadic operators comprise:
a first dyadic operator configured to extract data with a lesser value between the first input data and the second input data, and to generate the first result data; and
a second dyadic operator configured to extract data with a greater value between the first input data and the second input data, and to generate the second result data.

9. The SIMD operation apparatus of claim 2, wherein, when the single instruction corresponds to a butterfly instruction, the pieces of input data comprise first input data, second input data, and third input data, and
wherein the dyadic operators comprise:
a first dyadic operator configured to perform addition of the first input data and the second input data, and to generate the first result data;
a second dyadic operator configured to perform subtraction of the second input data from the first input data, and to generate intermediate result data; and
a third dyadic operator configured to perform complex multiplication of the intermediate result data and the third input data, and to generate the second result data.

10. The SIMD operation apparatus of claim 9, further comprising:
an intermediate register configured to store the intermediate result data,
wherein the third dyadic operator loads the intermediate result data from the intermediate register, and generates the second result data.

11. A single instruction multiple data (SIMD) operation apparatus, comprising:
dyadic operators configured to perform dyadic operations on pieces of input data; and
registers configured to store pieces of result data generated by the dyadic operators, respectively,
wherein the registers are grouped.

12. The SIMD operation apparatus of claim 11, wherein the dyadic operators perform dyadic operations comprised in a single instruction.

13. The SIMD operation apparatus of claim 11, further comprising:
an intermediate register,
wherein the dyadic operators store intermediate result data in the intermediate register.

14. The SIMD operation apparatus of claim 11, wherein the registers independently output the pieces of result data respectively stored in the registers.

15. The SIMD operation apparatus of claim 11, wherein the dyadic operators perform dyadic operations, in parallel, on the pieces of input data.

16. The SIMD operation apparatus of claim 11, wherein the pieces of input data, and the pieces of result data are vector data, or dual vector data, and
wherein the registers are vector registers.

17. A single instruction multiple data (SIMD) operation method, comprising:
generating first result data and second result data by performing a dyadic operation on pieces of input data;
storing the first result data in a first register; and
storing the second result data in a second register,
wherein the first register and the second register are paired with each other.

18. A single instruction multiple data (SIMD) operation method, comprising:
generating pieces of result data by performing a dyadic operation on pieces of input data; and
storing the pieces of result data in registers, respectively,
wherein the registers are grouped.

19. A single instruction multiple data (SIMD) operation apparatus, comprising:
dyadic operators configured to generate pieces of result data by performing dyadic operations on pieces of input data; and
grouped registers configured to store the pieces of result data.

20. The SIMD operation apparatus of claim 19, wherein a dyadic operation performed by each of the dyadic operators is comprised in a single instruction.
